(19) United States
(12) Patent Application Publication
(10) Pub. No.: US 2026/0195629 A1
(43) Pub. Date: Jul. 9, 2026

(54) MECHANICALLY MEDIATED QUANTUM SYSTEMS

(71) Applicant: President and Fellows of Harvard College, Cambridge, MA (US)

(72) Inventors: Long Fung Frankie FUNG, Cambridge, MA (US); Emma ROSENFELD, Cambridge, MA (US); John DaLi SCHAEFER, Cambridge, MA (US); Katherine VAN KIRK, Cambridge, MA (US); Xu ZHOU, Cambridge, MA (US); Amir YACOBY, Cambridge, MA (US); Mikhail D. LUKIN, Cambridge, MA (US); Trisha MADHAVAN, Cambridge, MA (US); Nabeel ASLAM, Leipzig (DE)

(21) Appl. No.: 19/131,409

(22) PCT Filed: Nov. 21, 2023
(86) PCT No.: PCT/US2023/080710

§ 371 Date: May 20, 2025

Related U.S. Application Data
(60) Provisional application No. 63/427,092, filed on Nov. 21, 2022.
(60) Provisional application No. 63/515,039, filed on Jul. 21, 2023.

(51) Int. Cl. G06N 10/40; G01Q 70/06; G01Q 70/14

(52) U.S. Cl. CPC G06N 10/40; G01Q 70/06; G01Q 70/14

(57) ABSTRACT

Systems and methods relate to mechanically mediated coupling of qubits to a mechanical resonator. Individual qubits can be coupled to a mechanical resonator, which can in turn couple to a second qubit that is separated from the first in distance, time, or both. Such mechanically mediated coupling can produce entangled qubit states over long distances and timescales. Arrays of qubits and/or mechanical resonators can be used to scale mechanically mediated coupling to larger numbers of qubits.

### CROSS-REFERENCE TO RELATED APPLICATIONS

This application claims the benefit of priority to U.S. Provisional Application No. 63/427,092, entitled “A Scanning Probe Spin-Mechanical Platform with NV Centers and high-Q Clamped Nanostring,” filed on Nov. 21, 2022, and to U.S. Provisional Application No. 63/515,039, entitled “Programmable Quantum Processors Based on Spin Qubits with Mechanically-Mediated Interactions and Transport,” filed on Jul. 21, 2023, the disclosures of which are hereby incorporated by reference in their entirety.

### STATEMENT OF GOVERNMENTAL INTEREST

This invention was made with government support under 2012023 and 1734011 awarded by National Science Foundation (NSF) and under DE-AC02-05CH11231 awarded by U.S. Department of Energy (DOE) and under N00014-15-1-2761 awarded by U.S. Office of Naval Research (NAVY/ONR). The government has certain rights in this invention.

### TECHNICAL FIELD

The invention relates to quantum systems, and more particularly to transferring a quantum state using mechanically mediated interactions.

### COPYRIGHT NOTICE

This disclosure can contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### BACKGROUND

A quantum register is the quantum computing analog to a processor register in classical computing. A quantum register allows for the manipulation of quantum bits, or qubits, to perform quantum calculations.

Isolated spin defects in the solid state, such as nitrogen vacancy (NV) centers in diamond, can be used for quantum information processing. Such spin defects have extended coherence times even at elevated temperatures, which are useful characteristics for quantum information processing.

Small quantum registers based on quantum spins have typically relied on magnetic dipole-dipole interactions to couple electronic and nuclear spins. These magnetic interactions limit the distance between spins to tens of nanometers. The short-range nature of these interactions and imprecision of defect fabrication at these length scales make it challenging to control systems containing arrays of spin qubits.

### SUMMARY

According to some embodiments, an apparatus, comprising: a plurality of scanning probes, each scanning probe having a spin qubit; a mechanical resonator; and at least one magnet attached to the mechanical resonator, the at least one magnet configured to couple a mechanical resonance of the mechanical resonator to: a spin state of a spin qubit of a first scanning probe of the plurality of scanning probes, and a spin qubit of a second scanning probe of the plurality of scanning probes such that the spin state of the spin qubit of the first scanning probe is entangled with the spin qubit of the second scanning probe.

In some embodiments, one or more of the at least one magnet, the first scanning probe, or the second scanning probe is configured to move such that: the at least one magnet is configured to couple the mechanical resonance of the mechanical resonator to the spin state of the spin qubit of the first scanning probe of the plurality of scanning probes when the at least one magnet is in proximity to the spin qubit of the first scanning probe, and the at least one magnet is configured to couple the mechanical resonance of the mechanical resonator to the spin qubit of the second scanning probe of the plurality of scanning probes such that the spin state of the spin qubit of the first scanning probe is entangled with the spin qubit of the second scanning probe when the at least one magnet is in proximity to the spin qubit of the second scanning probe.

In some embodiments, the at least one magnet comprises at least two magnets attached to the mechanical resonator; one of the at least two magnets is configured to couple the mechanical resonance of the mechanical resonator to the spin state of the spin qubit of the first scanning probe; and another of the at least two magnets is configured to couple the mechanical resonance of the mechanical resonator to the spin qubit of the second scanning probe such that the spin state of the spin qubit of the first scanning probe is entangled with the spin qubit of the second scanning probe.

In some embodiments, the one of the at least two magnets is in proximity to the spin qubit of the first scanning probe and the another of the at least two magnets is in proximity to the spin qubit of the second scanning probe such that the spin state of the spin qubit of the first scanning probe is entangled with the spin qubit of the second scanning probe.

In some embodiments, one or more of the at least two magnets, the first scanning probe, or the second scanning probe are configured to move such that: the one of the at least two magnets is in proximity to the spin qubit of the first scanning probe, and the another of the at least two magnets is in proximity to the spin qubit of the second scanning probe.

In some embodiments, the at least one magnet comprises one magnet.

In some embodiments, the mechanical resonator comprises a nanobeam, a microbeam, a membrane, or a cantilever.

In some embodiments, the mechanical resonator comprises silicon nitride, silicon, or diamond.

In some embodiments, the at least one magnet comprises at least one micromagnet.

In some embodiments, the plurality of scanning probes comprise nanopillars.

In some embodiments, the plurality of scanning probes comprise a tapered cylinder shape.

In some embodiments, the plurality of scanning probes comprise diamond or silicon carbide.

In some embodiments, the spin state of spin qubit on the first scanning probe is configured to be set by microwave control of the electronic spin or by a laser.

In some embodiments, the microwave control is configured to be supplied to the spin qubit of the first scanning probe by a coplanar waveguide, an antenna, or a wire loop.

In some embodiments, one or more of the spin state of the spin qubit of the first scanning probe and the spin state of the spin qubit of the second scanning probe is configured to be read by a laser.

In some embodiments, one or more of the spin state of the spin qubit of the first scanning probe and the spin state of the spin qubit of the second scanning probe are configured to be transferred into long-lived nuclear spin states when the at least one magnet is in proximity to the spin qubit of the first scanning probe or the spin qubit of the second scanning probe, respectively.

In some embodiments, a second mechanical resonator; and a second at least one magnet attached to the second mechanical resonator, the second at least one magnet configured to couple a mechanical resonance of the second mechanical resonator to: a spin state of a spin qubit of a third scanning probe of the plurality of scanning probes, and a spin qubit of a fourth scanning probe of the plurality of scanning probes such that the spin state of the spin qubit of the third scanning probe is entangled with the spin qubit of the second scanning probe.

In some embodiments, the plurality of scanning probes comprise at least one array of scanning probes and the mechanical resonance of the mechanical resonator is selectively couplable to respective spins of spin qubits of scanning probes on the at least one array of scanning probes.

According to some embodiments, a method includes setting a spin state of a spin qubit on a first scanning probe; coupling a mechanical resonance of a mechanical resonator to the spin state of the spin qubit on the first scanning probe using at least one magnet attached to the mechanical resonator; and coupling the mechanical resonance of the mechanical resonator to a spin qubit of a second scanning probe using the at least one magnet such that the spin state of the spin qubit on the first scanning probe is entangled with the spin qubit of the second scanning probe.

In some embodiments, coupling the mechanical resonance of the mechanical resonator to the spin qubit of the second scanning probe comprises moving one or more of the second scanning probe or the at least one magnet such that the at least one magnet is in proximity to the spin qubit of the second scanning probe.

In some embodiments, the at least one magnet comprises at least two magnets attached to the mechanical resonator, and coupling the mechanical resonance of the mechanical resonator to the spin qubit of the second scanning probe comprises: coupling the mechanical resonance of the mechanical resonator to the spin state of the spin qubit of the first scanning probe using one of the at least two magnets; and coupling the mechanical resonance of the mechanical resonator to the spin qubit of the second scanning probe such that the spin state of the spin qubit of the first scanning probe is entangled with the spin qubit of the second scanning probe using a second one of the at least two magnets.

In some embodiments, the method further includes moving the one of the at least two magnets into proximity to the spin qubit of the first scanning probe and moving the another of the at least two magnets is in proximity to the spin qubit of the second scanning probe such that the spin state of the spin qubit of the first scanning probe is entangled with the spin qubit of the second scanning probe.

In some embodiments, the method further includes one or more of the at least two magnets, the first scanning probe, or the second scanning probe such that: the one of the at least two magnets is in proximity to the spin qubit of the first scanning probe, and the another of the at least two magnets is in proximity to the spin qubit of the second scanning probe.

In some embodiments, the mechanical resonator comprises a nanobeam, a microbeam, a membrane, or a cantilever.

In some embodiments, the mechanical resonator comprises silicon nitride, silicon, or diamond.

In some embodiments, the at least one magnet comprises at least one micromagnet.

In some embodiments, the plurality of scanning probes comprise nanopillars.

In some embodiments, the plurality of scanning probes comprise a tapered cylinder shape.

In some embodiments, the plurality of scanning probes comprise diamond or silicon carbide.

In some embodiments, the method further includes setting the spin state of spin qubit on the first scanning probe by microwave control of the electronic spin or by a laser.

In some embodiments, the method further includes supplying the microwave control to the spin qubit of the first scanning probe by a coplanar waveguide, an antenna, or a wire loop.

In some embodiments, the method further includes reading the one or more of the spin state of the spin qubit of the first scanning probe and the spin state of the spin qubit of the second scanning probe by a laser.

In some embodiments, the method further includes transferring one or more of the spin state of the spin qubit of the first scanning probe and the spin state of the spin qubit of the second scanning probe into long-lived nuclear spin states when the at least one magnet is in proximity to the spin qubit of the first scanning probe or the spin qubit of the second scanning probe, respectively.

In some embodiments, the method further includes coupling a mechanical resonance of a second mechanical resonator to the spin state of the spin qubit on a third scanning probe using a second at least one magnet attached to the second mechanical resonator; and coupling the mechanical resonance of the second mechanical resonator to a spin qubit of a fourth scanning probe using the second at least one magnet such that the spin state of the spin qubit on the third scanning probe is entangled with the spin qubit of the fourth scanning probe.

In some embodiments, the plurality of scanning probes comprise at least one array of scanning probes and the mechanical resonance of the mechanical resonator is selectively couplable to respective spins of spin qubits of scanning probes on the at least one array of scanning probes.

In some embodiments, the at least one magnet comprises one magnet.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements:

FIGS. 1A-1E show example systems for mechanically mediated coupling, according to some embodiments of the present disclosure.

FIGS. 2A-2E show spatial field characteristics resulting from a nanomagnet on a mechanical resonator, according to some embodiments of the present disclosure.

FIGS. 3A-3F show measurements from example implementations of systems for mechanically mediated coupling, according to some embodiments of the present disclosure.

FIG. 4 shows example parametric permutations that can provide for a value of C≥1, according to some embodiments of the present disclosure.

FIGS. 5A-5C show an apparatus for mechanically mediated entanglement of distant qubits, according to some embodiments of the present disclosure.

FIGS. 6A-6C show pulse sequences and measurements demonstrating preservation of spin coherence while moving in a magnetic field, according to some embodiments of the present disclosure.

### DESCRIPTION

Solid state spin qubits are useful tools for quantum information processing. For example, coherently coupled hybrid quantum systems consisting of spins and mechanical resonators can be used as a tool in quantum information processing and science. However, controlled interactions and entanglement in large, multi-qubit systems at large length scales are difficult to achieve.

The present disclosure describes coupled hybrid quantum systems including at least one quantum spin coupled to at least one mechanical resonator. By coupling one or more quantum spins to a mechanical resonator, the quantum state of the qubit can be stored for a period of time and/or transferred to another qubit (or the same qubit) at the same or a later time. In some examples, two or more qubits can be entangled via simultaneous or successive interaction with the same mechanical resonator. Embodiments of the present disclosure provide for deterministic entanglement between distant spin qubits.

Several approaches can address the challenge of controlling arrays of spin qubits. Examples include long-range entanglement based on photonic and mechanical systems. Nanomechanical resonators can be used for mesoscopic interface between distant and otherwise isolated spin qubits. For example, coherent interactions between two-level systems and macroscopic, high quality factor (high-Q), mechanical resonators can be used to prepare non-thermal states of a macroscopic object, generate squeezed states, and perform fundamental tests of quantum mechanics. Such a hybrid quantum system can be implemented by combining electronic spins with magnetically functionalized mechanical resonators, such as those with spin and mechanical degrees of freedom that are coupled through a magnetic field gradient. Mechanical resonators can be engineered to have very high quality factors (e.g., Q>10⁹ in silicon nitride mechanical resonators) with flexible, compact geometric configurations, and can feature low crosstalk relative to their electromagnetic counterparts. Using mechanical modes of the mechanical resonator as a quantum transducer, spin qubits that are separated by large distances or in time can be entangled deterministically, even when the mechanical mode is in a highly thermal state and subject to noise. Furthermore, the non-linearity of the spin can be used to cool the mechanical resonator to its ground state and subsequently prepare non-Gaussian states of motion. Among other solid-state technologies, this mechanically-mediated approach is complementary to coupled oscillator and strain-mediated platforms, owing to the inherent nonlinearity of the electron spin, wide-ranging geometries, and large coupling strengths made possible by careful positioning of a nanomagnet or micromagnet.

Strong coupling between mechanical systems and individual spin qubits is a challenging task, which can involve providing deterministic positioning of spin qubits in close proximity (e.g., less than 1 micrometer, less than 100 nanometers, or on the order of tens of nanometers) to magnetized mechanical resonators. Moreover, even though transducers can extend the spin-spin interaction range, the system connectivity is local, which can limit programmability and scalability.

Embodiments of the present disclosure describe systems and methods for programmable and/or long range control of single or multi-qubit spin systems in which individual qubits, such as nitrogen-vacancy (NV) centers in diamond nanopillars, are coupled to mechanical resonators, such as magnetically functionalized silicon nitride mechanical resonators. The NV centers can be implemented in a scanning probe architecture. Programmable connectivity, such as entanglement, between qubits can be implemented via interactions with mechanical resonators. Accordingly, quantum states can be transported across large distances and/or extended timescales.

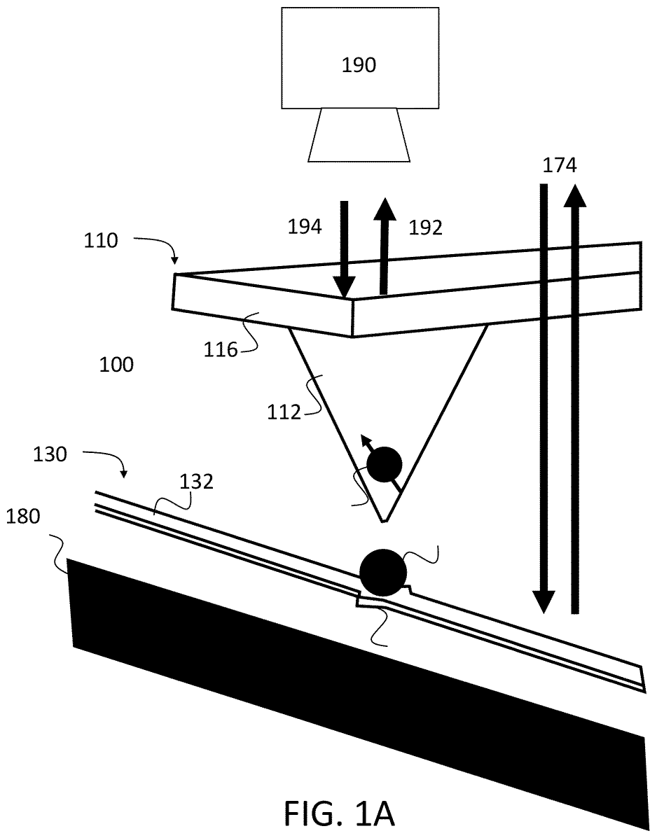

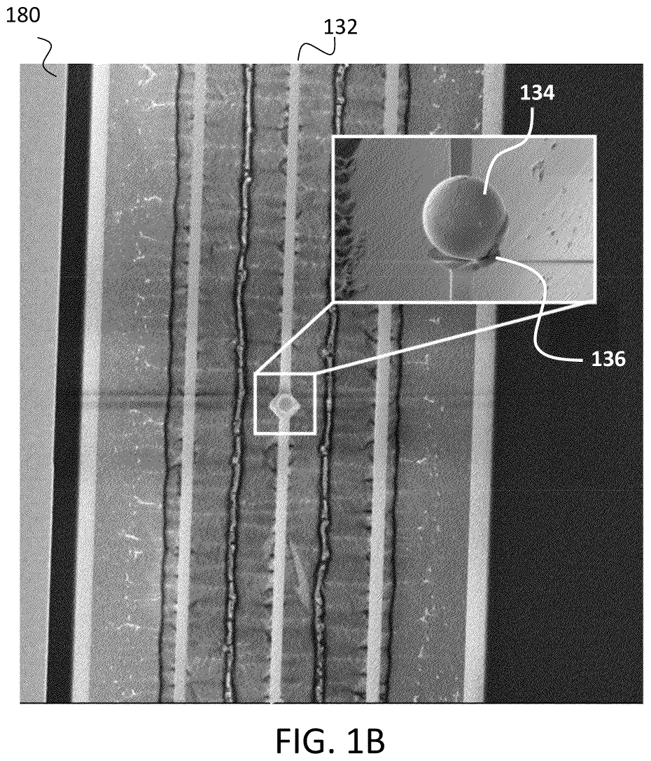

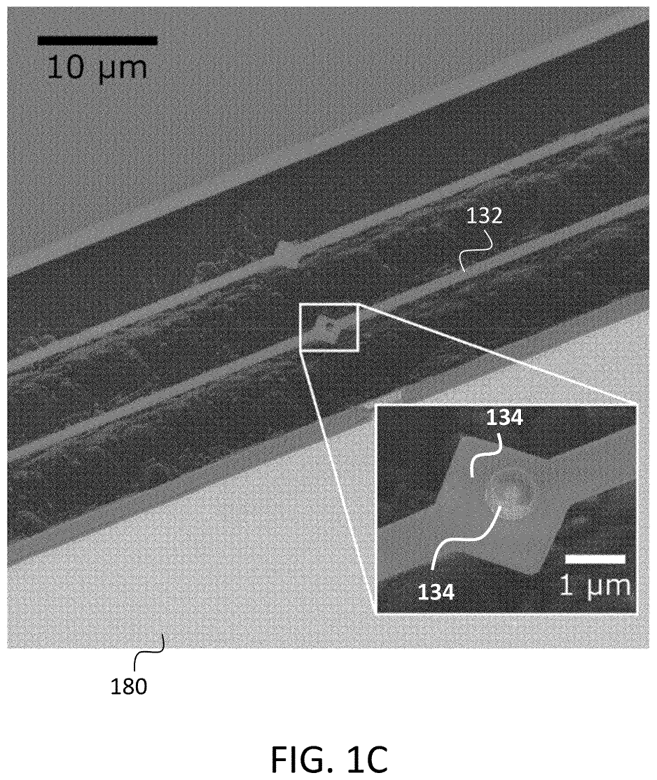

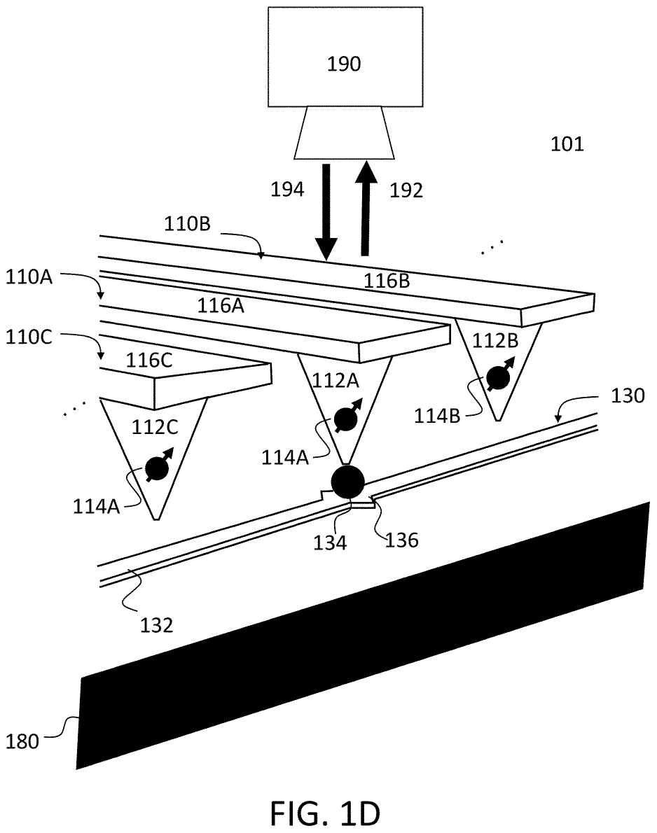

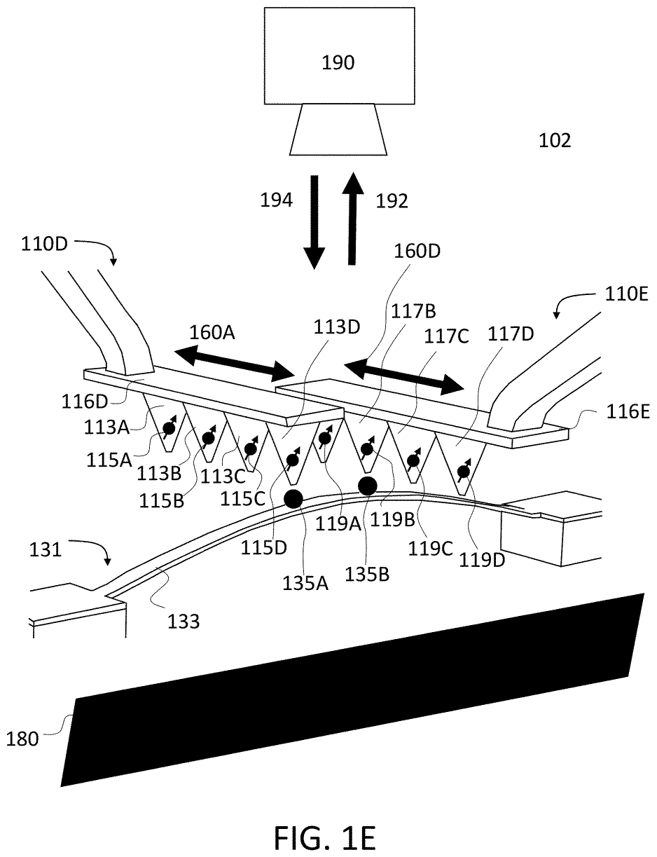

FIG. 1A shows an example system 100 for coupling a spin qubit 114 with a mechanical resonator 130, according to some embodiments. Qubit 114 can be disposed in such a fashion that permits mechanical translation on one or more axes in order to bring qubit 114 into proximity to mechanical resonator 130 to enable mechanically mediated interaction between the qubit 114 and mechanical resonator 130. For example, as shown in FIG. 1A, a qubit 114 is included in a nanopillar 112 of a probe 110. Nanopillar 112 can be, for example, a diamond nanopillar. Nanopillar 112 is connected to nanobeam or microbeam 116, which can be connected to an actuator, such as a 3-axis piezoelectric stage, such that the qubit 114 can be scanned along three axes. In some embodiments the qubit 114 is a single qubit or an ensemble of qubits. In some embodiments, nanopillar 112 can be manufactured with a small surface area at its apex (e.g., in the shape of a cone, with a taper, etc.), which can provide for closer placement of the qubit 114 to other objects such as a magnet without adhesion thereto, more efficient optical collection of photons emitted by the qubit 114.

Mechanical resonator 130 can be any magnetically functionalized mechanical resonator that resonates in accordance with the motion of a magnetized portion of the mechanical resonator 130, according to some embodiments. For example, as shown in FIG. 1A, mechanical resonator 130 includes a nanobeam or microbeam 132. The nanobeam 132 is magnetically functionalized by attaching a nanomagnet 134, such as a neodymium microsphere/NdFeB spherical nanomagnet, at the antinode of motion 136 (e.g., at its center). In some embodiments, nanomagnet 134 is affixed to the nanobeam 132 using, for example, glue. In some embodiments the nanobeam 132 is magnetically functionalized through other means, such as the use of lithography and/or metal deposition to form a magnet, and/or by use of a focused ion beam (FIB) to attach a magnet. The nanomagnet 134 creates a magnetic field gradient in the location of the qubit 114. Mechanical vibrations of the nanomagnet 134 and nanobeam 132 produce a time-varying magnetic field gradient at the location of the qubit 114.

In some embodiments, the nanobeam 132 can be fabricated on a chip, such as a silicon microchip. The nanobeam can be, for example, a doubly clamped silicon nitride nanobeam, according to some embodiments. The chip can include one or more coplanar waveguides and/or microwave antennae 180, such as a microwave stripline, fabricated onto the sample chip. In some embodiments, the microwave antenna facilitates coherent microwave spin control of the electronic spin of the qubit 114. In some embodiments, the chip and probe 110 can be placed in a vacuum chamber. In some embodiments, the system chip and probe 110 can be cooled, for example to approximately 20 K in a continuous flow cryostat. In some embodiments the system chip and probe 110 is cooled to approximately 4k using, for example, liquid helium. In some embodiments, the chip can be coupled to an actuator, such as a 3-axis piezoelectric stage or a 3-axis nanopositioner stack. Such actuator can be used in addition to or as an alternative to the actuator for the probe 110 to facilitate relative motion between the qubit 114 and nanomagnet 134.

In some embodiments, a reflective coating can be introduced to the nanomagnet(s), which can reduce heating from optical illumination and facilitate closer placement of the qubit 114 to the nanomagnet 134. Without being bound by theory, since coupling strength between the qubit 114 and nanomagnet 134 can scale as 1/r⁴, closer placement can improve coupling strength.

In some embodiments, a confocal microscope 190 can be provided, for example into the vacuum chamber, to initialize qubit 114 with light 194 (e.g., laser light) and to optically readout the qubit 114 via light 192 emitted from qubit 194. In some embodiments, an interferometer (such as a free-space or an integrated interferometer as part of the microscope 190) can be included to independently characterize the mechanical motion of the qubit 114. Light to/from the interferometer is shown traveling in the direction 174.

In some embodiments, during operation of system 100, nanopillar 112 containing qubit 114 can be positioned near the center near the nanomagnet 134 such that it is exposed to a larger magnetic field gradient such that the magnetic field experienced by qubit 114 varies more during vibration of the mechanical resonator 130. In some embodiments, higher magnetic field gradients can be accomplished using a tapered nanopillar 112, which allows for closer placement of the qubit 114 near the nanomagnet 134. Qubit 114 can be optically initialized according to known methods into a known quantum state using light 194 and/or antenna 180. The spin state of the qubit 114 can be coupled to the mechanical resonance of the nanobeam 132, for example by being placed in close proximity to the nanomagnet 134. For example, a series of π-pulses can be supplied by the coplanar waveguide/microwave antenna 180 to the qubit 114, which can flip its magnetic moment at the frequency of the mechanical resonator 130, which can in turn induce coherent motion of the nanobeam 132. The probe 110 can then be moved away from the mechanical resonator 130, leaving the mechanical resonator 130 coupled to a spin state of the spin qubit 114.

FIG. 1B is a scanning electron microscope (SEM) image of an example SiN (silicon nitride) nanobeam 132 having a nanomagnet 134 located on a pad 136 at the antinode of motion of the nanobeam 132, according to some embodiments. In some embodiments, the nanobeam 132 has a width of 1 μm.

FIG. 1C is a second SEM image of a nanobeam 132 with a nanomagnet 134 located on a pad 136 at the antinode of motion of the nanobeam 132, according to some embodiments. Also shown in FIG. 1B is an example microwave antenna 180, which can be a coplanar waveguide.

FIG. 1D shows an example system 101 for coupling one or more of a plurality of spin qubits 114A-114C with a mechanical resonator 130, according to some embodiments. As shown in FIG. 1D, a plurality of probes 110A-110C include a nanobeam 116A-116C, a nanopillar 112A-112C, and a qubit 114A-114C, respectively. As with FIG. 1A, the system 101 also includes a mechanical resonator 130 with a nanobeam 132 and a nanomagnet 134 at an antinode 136 of the nanobeam 132. An antenna 180 and confocal microscope 190 can also be included, according to some embodiments. In some embodiments, probes 110A-110C are connected to the same piezoelectric stage to permit 3-axis motion. In some embodiments, each probe 110A-110C is connected to a separate piezoelectric stage to permit 3-axis motion. Although FIG. 1D shows three probes 110A-110C, a person of skill in the art would understand from the present disclosure that fewer (e.g., two probes) or more than three probes could be used.

As shown in FIG. 1D, in some embodiments, during operation, a first nanopillar 112A containing qubit 114A can be positioned near the center near the nanomagnet 134. Qubit 114A can be optically initialized according to known methods into a known quantum state using light 194 and/or antenna 180. The spin state of the qubit 114A can then be coupled to the mechanical resonance of the nanobeam 132. For example, a series of π-pulses can be supplied by the coplanar waveguide/microwave antenna 180 to the qubit 114A, which can flip its magnetic moment at the frequency of the mechanical resonator 130, which can in turn induce coherent motion of the nanobeam 132. The probe 110A can then be moved away from the mechanical resonator 130, leaving the mechanical resonator 130 coupled to a spin state of the spin qubit 114A. In some embodiments, a second probe 110B (or 110C) can be positioned near the center near the nanomagnet 134 while the mechanical resonator remains coupled to the qubit 114A. The spin state of the qubit 114B (or 114C) can then be coupled to the mechanical resonance of the mechanical resonator 130. For example, a second series of π-pulses can be applied by the microwave antenna 180 to the qubit 114B (or C), which can cause constructive or destructive interference of the motion of the mechanical resonator 130, depending on the phase of the pulse train relative to the first one. Finally, a measurement of the mechanical motion of the mechanical resonator 130 projects the two qubits 114A and 114B (or 114C) into an entangled Bell pair. Accordingly, two qubits 114A and 114B (or 114C) can be prepared in an entangled state without requiring (1) both qubits to be in close proximity to the mechanical resonator 130 at the same time and/or (2) both qubits to be in close proximity to each other during entanglement. Entanglement of any two qubits can be achieved over any distance or time scale provided that the qubits and resonator maintain coherence during such time scales and can move at sufficient speed. For example, spin qubits confined in nanopillars can be moved mechanically in and out of the nearfield of the magnetized resonators. In some embodiments, the qubits can be transported across relatively long (e.g., 10-100 μm) distances, enabling non-local connectivity between distant qubits.

FIG. 1E shows another example system 102 for coupling two arrays of spin qubits 115A-115D, 119A-119D with a mechanical resonator 133, according to some embodiments. As shown in FIG. 1E, two probes 110D, 110E each comprise a microbeam 116D, 116E, respectively, according to some embodiments. Each nanobeam 116D, 116E includes a plurality of nanopillars 113A-113D, 117A-117D, respectively. Each nanopillar 113A-113D, 117A-117D has a qubit 115A-115D, 119A-119D, respectively. Nanopillars 113A-113D, 117A-117D can be positioned in any arrangement along microbeams 116D, 116E, respectively, for example in a longitudinal array, as shown in FIG. 1E.

System 102 also includes a mechanical resonator 131, according to some embodiments. In the example of FIG. 1E, mechanical resonator 131 includes a microbeam 133. The microbeam 133 is magnetically functionalized by attaching two nanomagnets 135A, 135B, such as an NdFeB spherical nanomagnet, at separate antinodes of motion of the microbeam 133 or adjacent to the same antinode of motion. Accordingly, nanomagnets 135A, 135B operate in a common mechanical mode of the microbeam 113.

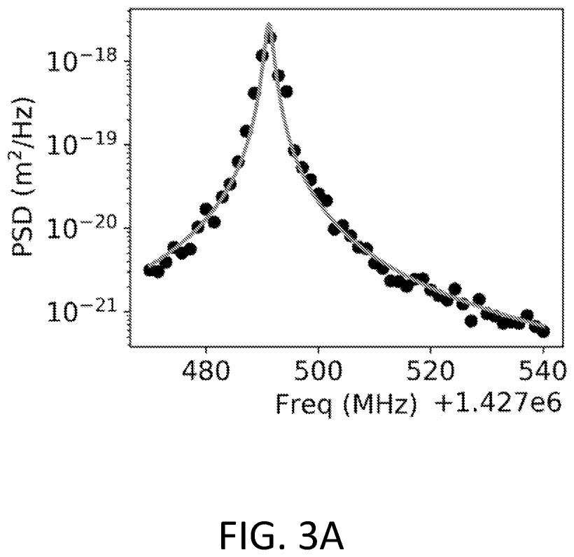

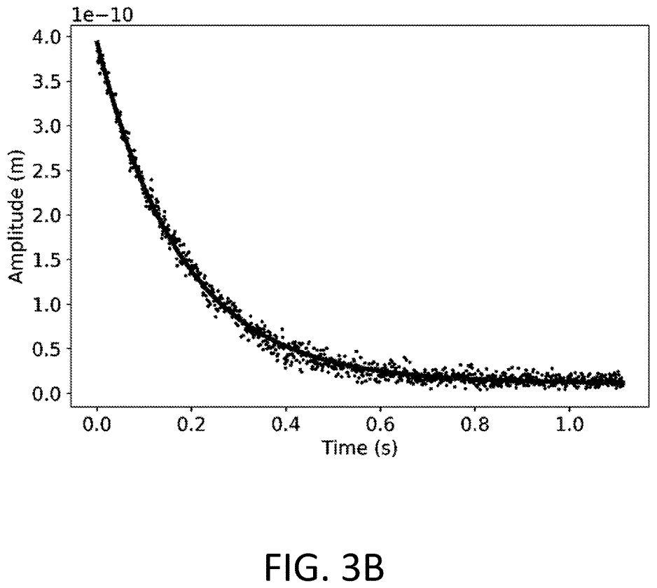

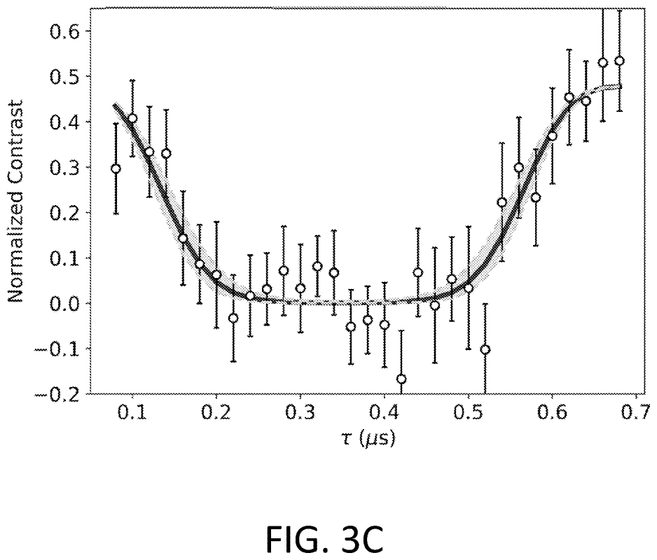

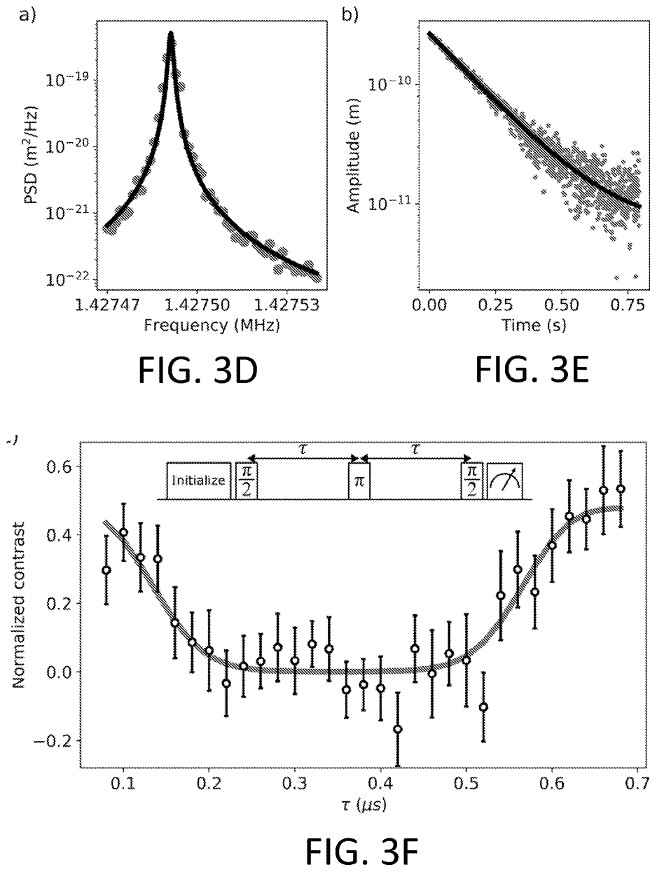

In some embodiments, each probe 110D, 110E is positioned above a respective nanomagnet 135A, 135B. For example, in some embodiments, probes 110D, 110E are mounted on the same or separate actuators, such as 3-axis piezoelectric actuators, to permit motion. For example, as shown in FIG. 3E, probes 110D, 110E are mounted on separate actuators to permit each probe to perform in-axis translation along black arrows 160A, 160D, respectively. Translation of probes 110D, 110E can permit a different one of qubits 115A-115D and qubits 119A-119D to be positioned in proximity to (and thereby couplable to) nanomagnets 135A and 135B, respectively. Such an arrangement facilitates mechanically-mediated spin-spin interactions, such as entanglement/coupling, using the nanomagnets 135A, 135B and mechanical resonator 131, respectively. As with FIGS. 1A and 1D, antenna 180 and/or confocal microscope 190 can also be included in system 102 to facilitate manipulation and observation of the spin states of qubits 115A-115D, 119A-119D.

In some embodiments, during operation of the system 102, one qubit from each array of qubits 115A-115D, 119A-119D can be moved in proximity to nanomagnets 135A, 145B, respectively. With reference to FIG. 1E, qubits 115D and 119B can be optically initialized according to known methods into a known quantum state using light a from confocal microscope 190 and/or antenna 180. In some embodiments, a single microscope 190 is used for both qubits 115D and 119B. In some embodiments, each qubit is observed with a separate microscope. The spin states of the qubits 115D and 119B can then be coupled to the mechanical resonance of the microbeam 133 via nanomagnets 135A, 145B, respectively. For example, a series of π-pulses can be supplied by the microwave antenna 180 to the qubits 115D and 119B, which can flip their magnetic moment at the frequency of the mechanical resonator 131, which can in turn induce coherent motion of the microbeam 133. Finally, a measurement of the mechanical motion of the mechanical resonator 131 projects the two qubits 115D and 119B into an entangled Bell pair. Accordingly, two qubits 115D and 119B can be prepared in an entangled state without requiring (1) both qubits to be in close proximity to each other and/or (2) both qubits to be in close proximity to the same nanomagnet.

Variations on the above method are contemplated. According to some embodiments, the qubits 115D and 115B can be coupled to the mechanical resonator 131 at different times prior to measurement of the mechanical motion of the mechanical resonator 131. In some embodiments, either or both of the probes 110D, 110E are moved after coupling one or both of the qubits 115D and 115B to the mechanical resonator 131, and the coupling process is repeated for additional qubits from the arrays 115A-C and/or 115A, 115C-115D. Accordingly, ensembles of qubits (e.g., large ensembles of one hundred or more qubits) can be prepared across large distances and/or times.

Although FIG. 1E displays two probes 110D, 110E, two nanomagnets 135A, 135B, and a single mechanical resonator 131, additional probes, nanomagnets, and/or mechanical resonators can be implemented using the disclosed architecture (for example, by parallelizing the processes described above). For example, multiple mechanical resonators can simultaneously mediate interactions within selected qubits from large arrays of qubits at the same time or successively. Furthermore, by introducing optics that individually address qubits and/or additional microwave antennae, individualized control of particular qubits can be implemented across a large array of multiple probes, qubits, and/or resonators.

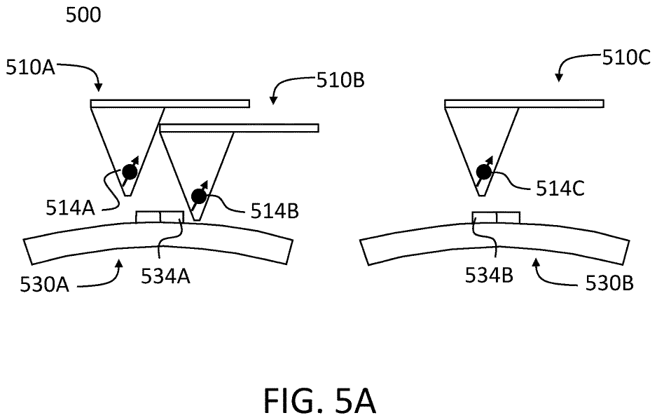

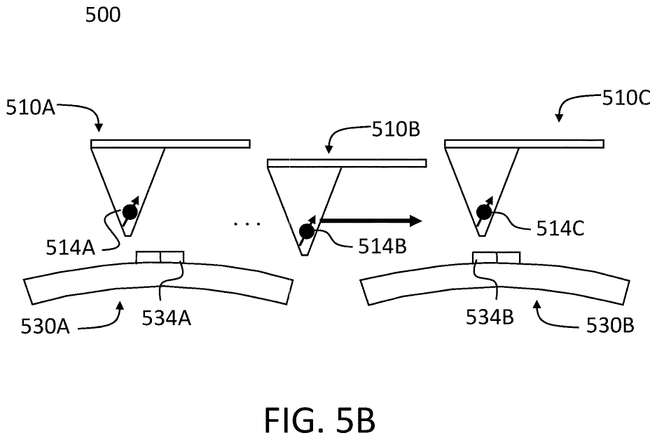

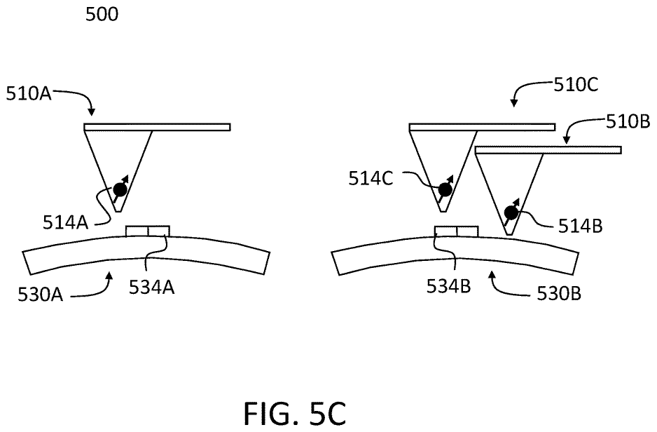

FIGS. 5A-5C show an apparatus 500 for mechanically mediated entanglement of distant qubits 514A, 514C via movable diamond nanopillars, according to some embodiments. As shown in FIGS. 5A-5C, a nanomagnets 534A, 534B are located on top of high-Q (e.g., on the order of 10\hat{ }6 Q or more, or 10\hat{ }8 Q or more, or 10\hat{ }9 Q or more) mechanical resonators 530A, 530B, respectively. A single qubit 514B is embedded at the tip of a nanopillar of probe 510B, allowing for minuscule separations (e.g., on the order of 10s of nm) between qubit 514B and nanomagnets 534A, 534B. A field gradient can be provided such that the motion of the mechanical resonators 530A, 530B can be entangled with the state of the qubit 514B, for example as shown in FIG. 5A. In some embodiments, probe 510B can be moved in a scanning fashion, for example in an atomic force microscope (AFM) configuration as shown in the transition from FIG. 5A to FIG. 5B, and from FIG. 5B to FIG. 5C. Moving the probe 510B allows for entanglement between the qubit 514B and multiple mechanical resonators, such as mechanical resonators 530A and 530B.

In some embodiments, mechanical resonators 530A, 530B can each be entangled with other qubits, such as qubits 514A and 514C on probes 510A and 510B, respectively. In such an arrangement, the spin state of qubit 514B can be entangled, for example, with the spin state of qubit 514A via mechanically mediated interactions with the nanomagnet 534A (FIG. 5A). Thereafter, the probe 510B can be moved (FIG. 5B) in proximity to probe 510C and nanomagnet 534B, and the states of qubits 514B and 514C can be entangled (FIG. 5C), for example using mechanically mediated interactions with the nanomagnet 534B. Accordingly, qubits 514A and 514C can be entangled over large distances.

In some embodiments, additional resonators and/or qubits are contemplated in the system 500. For example, qubit 514B can transfer spin states to more than one other qubit 514C. Furthermore, one or more of the qubits 514A-514C can store the entangled state, and therefore extend the movement time for such state. For example, the entangled state can first be stored on qubit 514B, which can then pass the entangled state on to qubit 514C, and so on, such that the entangled state can be transferred over larger distances and/or time scales than simply entangling two adjacent qubits.

### Example Field Gradients for Nanomagnets

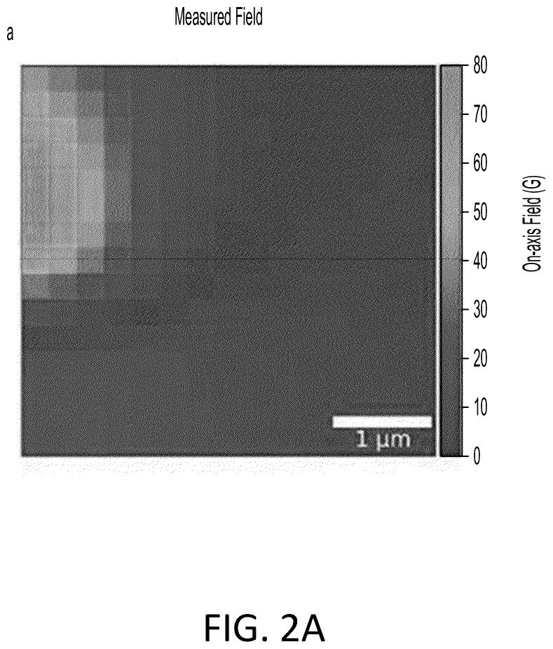

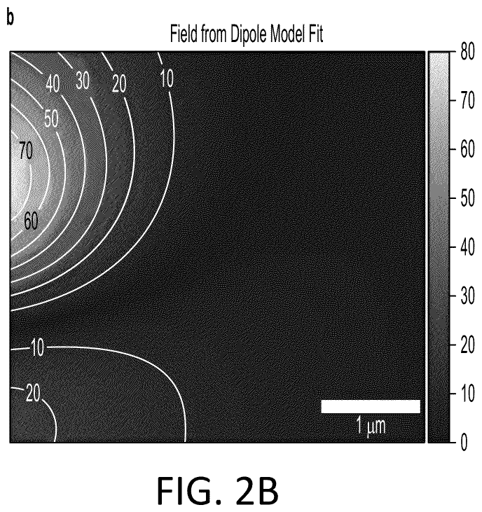

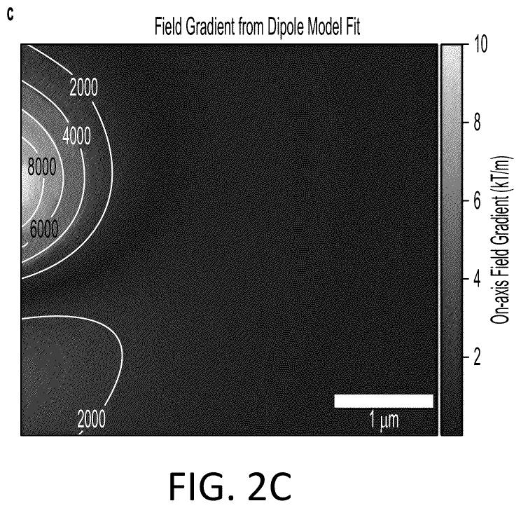

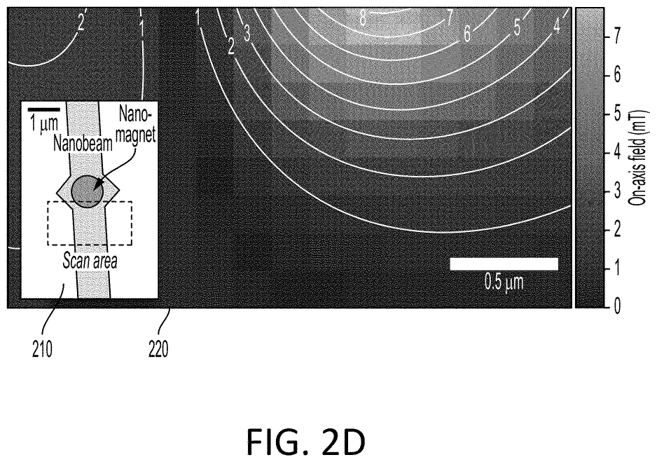

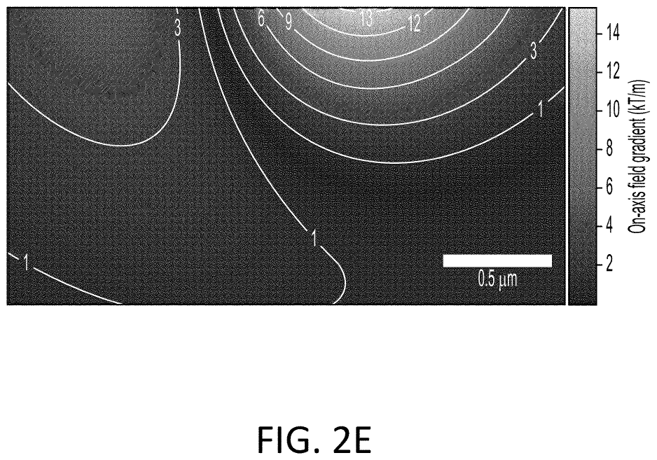

FIGS. 2A-2E show example field gradients resulting from a nanomagnet on a mechanical resonator, according to some example implementations of the embodiments of the present disclosure. FIGS. 2A-2E are merely examples, and are not intended to be limiting. As shown in FIGS. 2A-2E, the magnetic field gradients are of sufficient size in proximity to the nanomagnet such that adequate coupling can be achieved with a nearby qubit.

FIGS. 2A-2C show scanning field characterizations of an example nanomagnet 134 of FIG. 1A, according to some embodiments. FIG. 2A shows a magnetic field along the axis of the qubit 114 in an area around the nanomagnet 132, with a separation of about 1 μm between the tip of the nanopillar 112 and nanomagnet 134. For each position of the nanopillar 112, a microwave carrier frequency from microwave antenna 180 was scanned (e.g., swept across a range of frequencies) and the electron spin resonance (ESR) transitions of the qubit 114 were measured in the form of a drop in photoluminescence as detected by microscope 190, from which the magnetic field along the center axis of qubit 114 can be calculated. FIG. 2B shows an on-axis field reconstructed from the field measured in FIG. 2A, according to some embodiments. In some embodiments, the field is well-approximated by a dipole model, with the fit deviating from the measured fields by no more than 4 G at any point. FIG. 2C shows an example on-axis field gradient G calculated from parameters derived from FIG. 2B, according to some embodiments. In some embodiments, the peak gradient is approximately 1×10⁴ T/m, which is consistent with AC sensing measurements.

FIGS. 2D-2E show a more complete magnetic field image of a nanomagnet from FIGS. 2B and 2C, respectively, according to some embodiments. FIG. 2E includes a graph 220 of an image of a magnetic field in an area around the magnet taken by measurements from an implementation of FIG. 1A with a NV center qubit having a vertical NV-magnet separation of about 1 μm. Inset 210 shows the position of the image relative to the micromagnet. In some embodiments, the presence of a magnetic field perpendicular to the NV center quantization axis limits NV spin readout contrast, photoluminesence intensity, and coherence time T_{2,e} in a natural-abundance ¹³C diamond. In order to align the magnetic field and characterize the field distribution, the micromagnet can be scanned with respect to the diamond nanopillar with a 3-axis stack of piezoelectric nanopositioners. For each position of the diamond nanopillar, the (ESR) frequencies can be measured, from which the magnetic field along the NV center's axis can be extracted. In some embodiments, the field from the spherical micromagnet can be well-approximated by a dipole model, with the fit (contours) deviating from the measured fields by no more than 3 G at any point. The orientations of the NV center and magnet are consistent with existing fabrication processes of the nanopillar and magnetization direction, respectively. The example measurements presented in FIG. 2D were performed in air at room temperature, without any external driving of the mechanical resonator. FIG. 2E shows a reconstructed magnetic field gradients based on fit to dipole model based on data from FIG. 2D. In the example embodiment of FIG. 2E, the peak gradient is ~1.5×10⁴ T/m, corresponding to a single-phonon spin-mechanical coupling strength of λ/2π~5 Hz.

### Example Improvements to System Performance

Without being bound by theory, in some embodiments noise can be reduced or minimized and coupling strength can be increased to provide for more reliable and durable coupling of qubits to a mechanical resonator. For example, the onset of coherent quantum phenomena can be marked by a spin-mechanics cooperativity C=λ²/Γκnₜₕ≥1, which compares the coherent coupling rate λ to the dissipation rates Γ, κnₜₕ of the spin and mechanics respectively. It can be challenging to implement a spin-mechanics platform with high cooperativity (for example, cooperativity of close to or greater than 1). In some embodiments, to improve or maximize the coupling strength, both the resonator's zero-point motion and the magnetic field gradients should be large, for example greater than 10\hat{ }6 T/m. In some embodiments, to reduce or minimize noise, the spin can be configured to exhibit long coherence times, and the mechanical resonator can be configured to retain a high quality factor in proximity to the spin substrate. In some embodiments, strategies for magnetically coupling electronic spins in crystals to solid-state resonators include coupling NV centers in bulk diamond to cantilevers, with high quality factors but which can suffer from low frequencies. In some embodiments, strategies can include coupling higher-frequency nanowires to NV centers in nanodiamonds. While the small mass and correspondingly high zero-point motion of the nanowire can demonstrate impressive coupling strengths, the coherence times of NV centers in nanodiamonds can be short. Further, without being limited by theory or current experimental data, nanowires can have mechanical quality factors on the order of 10⁴ or less.

In some embodiments, and without being limited by theory, it can be desirable to increase the spin-mechanics cooperativity C. In some embodiments, a platform can include a doubly-clamped, nanofabricated, silicon nitride (SiN), high-Q microbeam and an NV center in the tip of a nearby diamond nanopillar to increase C. A nanomagnet affixed (e.g., glued) to the microbeam's antinode can provide a magnetic field gradient that couples the mechanical motion to the NV center's electronic spin states. The doubly-clamped geometry can utilize dissipation dilution to achieve high quality factors (e.g., >10\hat{ }6), and the diamond nanopillar's small footprint reduces or minimizes the distance between the nanomagnet and the NV center. Without being limited by theory, the Hamiltonian of the system can be expressed as:

$$H / ℏ = \frac{{ω}_{s}}{2} {σ}_{z} + {ω}_{r} {a}^{†} a + {λσ}_{z} ( a + {a}^{†} ) , \qquad ( 1 )$$

where a displacement of the mechanical mode a by the zero-point fluctuation zₚ shifts the Zeeman splitting of the NV center by λ/2π Hz, ωₛ is the Zeeman splitting of the spin (set by the bias or background magnetic field from the nanomagnet), and ωᵣ is the angular frequency of the fundamental mechanical mode.

In some example implementations, these techniques have resulted in improvements to system performance. For example, in an example implementation of the system of FIG. 1A, mechanical frequencies exceeding ~1 MHz, Q factors approaching 10⁶, and an NV center T₂ of ~100 μs to 1 ms have been observed. The example implementation included a high-remanence neodymium-iron-boron (NdFeB) nanomagnet as the source of the magnetic field gradient; a NV-nanomagnet distance r on the order of a few microns or 1 micron, and a nanomagnet radius of a~0.5-0.7 μm, corresponding to magnetic field gradients of ~10³-10⁴ T/m. The magnetic field and field gradients can be characterized by scanning the sample with respect to the diamond nanopillar. By interrogating the mechanical motion interferometrically and detecting the magnetic field oscillations with the NV center, a single-phonon coupling strength was determined to be λ/2π ~7.7-8.7 Hz, consistent with the magnetic gradients estimated by the scanning characterization. In some embodiments, by using known or future techniques to increase the Q factor and to reduce the magnet-NV center distance r relative to this example implementation, the cooperativity C may be increased to or beyond approximately 1.

### Example Implementations of the System of FIG. 1A

According to some embodiments, results are disclosed from an example implementation of the system of FIG. 1A. The results below are not intended to be limiting, and serve merely as an example.

In the example implementation, a spherical nanomagnet is used to generate a magnetic field given approximately by a dipole (for example, as shown in FIGS. 2A-2C) oriented in the direction perpendicular to the plane defined by the chip on which the mechanical resonator is mounted. The presence of a magnetic field perpendicular to the intrinsic NV center quantization axis can limit NV contrast, photoluminesence, and T₂ coherence time in a natural abundance ¹³C diamond. To improve or maximize the magnetic field along the NV quantization axis and to characterize the magnetic field distribution, the example implementation can be scanned with respect to the diamond nanopillar with a 3-axis piezoelectric nanopositioner (e.g., moving the chip with the mechanical resonator relative to the nanopillar), and the spin resonance spectrum can be measured at each position (for example, as shown in FIG. 2A). The spin transition frequencies of the NV center can change with distance and angle between the diamond tip and the nanomagnet, which can be detected optically using electron spin resonance (ESR) measurements (for example, as shown in FIG. 2A). The magnetic field along the NV quantization axis can be determined for each position and the results can be fitted to a dipole (for example, as shown in FIG. 2A). Gradients up to 1 ×10⁴ T/m, corresponding to an expected coupling strength of λ/2π ~5 Hz (for example, as shown in FIG. 2A), are estimated.

In some embodiments, it is possible to measure the mechanical motion of a mechanical resonator to determine the coupling strength of the qubit to the resonator. For example, the resonance characteristics of the mechanical resonator can be measured optically (i.e., based on interferometry) and based on the response of the qubit, and then compared to determine how strongly the qubit is coupled to the mechanical resonator.

For example, mechanical motion can be measured interferometrically, e.g., a near-infrared laser beam can be reflected off the resonator, interfered with a reference beam in a fiber-coupled beamsplitter, and detected with a lock-in amplifier. To excite the resonator, the resonator can be driven mechanically, such as by using a piezoelectric ceramic affixed (e.g., clamped) to the printed circuit board under the sample. FIG. 3A shows an example power spectral density of a mechanical mode position, measured interferometrically using a 1064 nm laser beam (incident power of roughly 150 μW) in vacuum), with a resonance frequency of 1.427491 MHz. As shown in the example of FIG. 3A, a Lorentzian lineshape (solid line) can be fit to the data with a linewidth of about K/2π=1.5 Hz. Accordingly, the resonator spectrum can follow a Lorentzian lineshape with frequencies in the ~1 MHz regime.

FIG. 3B shows the amplitude decay of the resonance mode after switching the mechanical drive off, which, in an example embodiment, can be measured as Q=8.1×10⁵ 8.25×10⁵.

In some embodiments, the mechanical motion of the mechanical resonator can be measured with the NV center, which facilitates calculation of the coupling strength 2 between the NV center and the mechanical resonator. For example, the resonator motion can be detected with the nearby NV center and fit the results for fixed frequency or and amplitude Δₓ values given by the interferometer measurements. Along with amplifying the mechanical signal by driving the resonator with a white noise source (raising its RMS amplitude), a Hahn echo pulse sequence can be used to extract the coupling strength and root-mean-square magnetic field amplitude of the mode. The Hahn echo pulse sequence, a series of three microwave pulses on the NV center, can result in frequency-dependent detection of the magnetic spin environment. The Hahn echo pulse sequence can be performed on the NV center with and without the mechanical drive, and the ratio is plotted (dots in FIG. 3C) such that NV center's decoherence can be neglected in example theoretical models for the fit (x(τ), solid line). According to equation (2) below, the signal S(τ, λ, Δₓ)/e^{-x(τ)} can be fit with Δₓ and ωᵣ as fixed parameters, to find λ/2π=8.7 Hz. The zero-point motion zₚ can be inferred from the material densities and sizes. For example, without being bound by theory, sweeping the time between the π pulses and assuming a thermal distribution of the mechanical state, the spin contrast can be approximated as

$$S ( τ , λ , {Δ}_{x} ) = {Ce}^{- 8 {Δ}_{x}^{2} {λ}^{2} {sin}^{4} ( {ω}_{r} τ / 2 ) / {ω}_{r}^{2} {z}_{p}^{2}} {e}^{- χ ( τ )} \qquad ( 2 )$$

where x(τ) describes the coherence decay from other noise sources in the diamond, e.g. the bath of ¹³C nuclear spins, and the contrast C~0.4 is determined by the spin-dependent optical initialization and readout as well as background fluorescence. To determine λ, Δₓ can be quantified by integrating the interferometer signal of the mechanical response from the wideband drive, and or can be assigned to the center frequency. For the illustrative data corresponding to the example implementation shown in FIG. 3C, ωᵣ/2π=1.427491 MHz and Δₓ=1.86-2.8 nm.

In some embodiments, a reflective coating can be introduced to the nanomagnet(s), which can reduce heating from optical illumination and facilitate closer placement of the qubit and nanomagnet. Without being bound by theory, since coupling strength between the qubit and nanomagnet can scale as 1/r⁴, closer placement can improve coupling strength. For example, reducing the distance between the qubit and the nanomagnet to r=0.5 μm can increase gradients to over 1×10⁵ T/m or λ/2π~100 Hz, corresponding to an example improvement in cooperativity by two orders of magnitude. In some embodiments, techniques such as strain engineering and soft-clamping in high-stress SiN beams can increase Q factors to ~1×10⁹ at MHz frequencies.

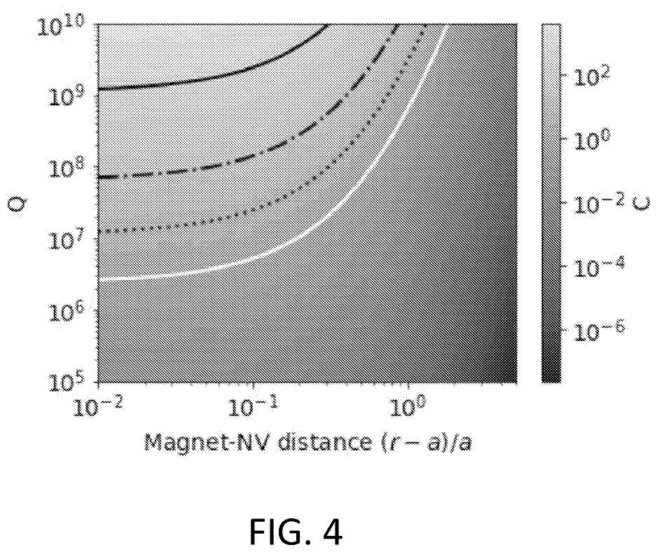

Without being bound by theory, FIG. 4 shows various example parametric permutations that can provide for a value of C≥1, according to some embodiments. The cooperativity C is shown for illustrative permutations of different Q factors (vertical axis) and distances between the NV and the surface of the magnet, normalized to its radius a (horizontal axis). The cooperativity C shown in FIG. 4 is determined using the following parameters: the NV T₂ coherence time is 1 ms, the mode is thermalized at 4 K, the magnet radius is a=0.5 μm, and the magnetic field from the magnet is Ma³/r³, where the magnetization is M=0.7 T, and the field is aligned to the NV axis. The white line corresponds to C=1. The black dotted line are example conditions for an NV-NV entanglement fidelity of [symbol] =0.7, the dashed-dotted line for [symbol] =0.9, and the solid line for [symbol] =0.99.

In some embodiments, cooperativity C~1 can be achieved in a system with a coupling strength of λ/2π=100 Hz, a nanopillar NV T₂ of 10 ms, and a quality factor of Q=10⁹, at 4 K. Without being bound by theory, increasing NV coherence times can be increased to the ~10 ms regime can be achieved with one or more of greater NV implantation depth, improvements in diamond fabrication, and improvements in surface termination. Cryogenic mode temperature can be achieved with improved vibration isolation. Mechanical dissipation can be improved by one or more of reducing clamping losses or an improving the magnetic functionalization process.

FIGS. 3D-3F show another example implementation of the embodiment of FIG. 1A. In particular, FIGS. 3D-3F show example characterizations of spin-mechanical coupling achieved by embodiments of the present disclosure. As with FIGS. 3A-3C, spin-mechanical coupling can be measured by exciting the microbeam and characterizing its mechanical motion via independent measurements with both an interferometer and a nearby NV center. In an example implementation, the scanning probe setup can be used in a helium cryostat to take advantage of higher quality factors at low temperatures.

FIGS. 3D-3E shows example interferometric measurements, according to some embodiments. FIG. 3D is a power spectral density (PSD) of the mechanical mode, measured using an interferometer. The dots show PSD as a function of frequency of oscillation caused by an external drive from a piezoelectric chip coupled to the nanomagnet of an example implementation of embodiments of the present disclosure. A Lorentzian fit is shown in a black line, which can be used to extract a mechanical resonance frequency ωᵣ~1.4 MHz and a linewidth of K/2π=1.5 (2) Hz, which corresponds to a period of 0.7 μs.

FIG. 3E shows the amplitude decay after switching of the external drive from a piezoelectric chip. Measurements of vibration amplitude as a function of time are shown with dots, and the fit line is shown in black. The quality facture calculated from this decay is Q=8.25 (6)×10⁵. According to some embodiments, this demonstrates that the quality factor can remain high despite magnetic functionalization. As a result, the mechanical resonator can undergo multiple oscillations during the spin coherence time T_{2,e}, which is around several microseconds. The readily accessible high mechanical frequency of the microbeam compares favorably to other spin-mechanical platforms, such as those featuring cantilevers, nanowires, and magnetic levitation.

FIG. 3F shows the results of sensing of the mechanical motion of the mechanical resonator with an NV center, according to an example implementation of embodiments of the present disclosure. In the example implementation, a Hahn echo pulse sequence was applied to the NV center with and without the mechanical drive present, which can results in a frequency-dependent detection of the magnetic spin environment. A displacement of the mechanical mode by the zero-point fluctuation zₚ shifts the NV center spin resonance by λ/2π via the Zeeman effect, can result in the single-phonon coupling strength λ= [symbol] ∇_{z}, where [symbol] is the NV center electronic spin gyromagnetic ratio, and ∇_{z} is the magnetic field gradient along the NV center quantization axis. To quantify the spin-mechanical coupling strength, the mechanical resonator can be excited with an external broadband drive and the resulting field from the oscillating micromagnet can be detected with the nearby NV center. The ratio (circles) is plotted in FIG. 3F such that the NV center's decoherence can be neglected in the model for the fit (X(τ), solid line). The signal S(τ, λ, Δₓ)/e^{-χ(τ)} (see eq. (3)) can be fit using fixed values of Δₓ and ωᵣ from interferometer measurements of the mechanical resonator, which yields a result of λ/2π=7.7 (9) Hz. The zero-point motion zₚ can be inferred from the material densities and dimensions of the mechanical resonator.

In example implementations, using a Hahn echo pulse sequence and sweeping the time t between the π pulses and assuming a Gaussian distribution of the mechanical state, the spin contrast can be approximated as

$$S ( τ , λ , {Δ}_{x} ) = α {e}^{- 8 {Δ}_{x}^{2} {λ}^{2} {sin}^{4} ( {ω}_{r} τ / 2 ) / {ω}_{r}^{2} {z}_{p}^{2}} {e}^{- χ ( τ )} \qquad ( 3 )$$

where Δₓ is the root-mean-squared amplitude of motion, a is the spin readout contrast, and χ(τ) x(τ) describes the coherence decay from other noise sources in the diamond, such as the bath of ¹³C nuclear spins.

In some example implementations, to determine λ, Δₓ can be independently quantified by integrating the interferometer signal of the mechanical response of the mechanical resonator from the wideband drive, and assign or to the center frequency. For the data corresponding to FIG. 3D, an example implementation yields Δₓ=1.86 (1) nm. The Hahn echo data can then be fit, normalized to a baseline Hahn echo measurement to compensate for intrinsic NV decoherence e^{-χ(τ)} (shown as dots in FIG. 3F). For the fit (solid line), ωᵣ and Δₓ can be fixed, leaving λ as a free parameter. According to data from an example implementation, as discussed above, λ/2π=7.7 (9) Hz, which corresponds to a field gradient of 2.4 (1)×10⁴ T/m, similar to the gradients from the static field imaging of the same magnet shown in FIG. 2D.

### Example Preservation of Spin Coherence During Motion of Qubit

According to some embodiments, results are disclosed from example implementations of the disclosed embodiments that provide for an extension of the spin coherence of a qubit while the qubit is mechanically displaced relative to the nanomagnet. According to the example results, the spin coherence is not affected by movement over 2 μm near the magnet. The results below are not intended to be limiting, and serve merely as an example.

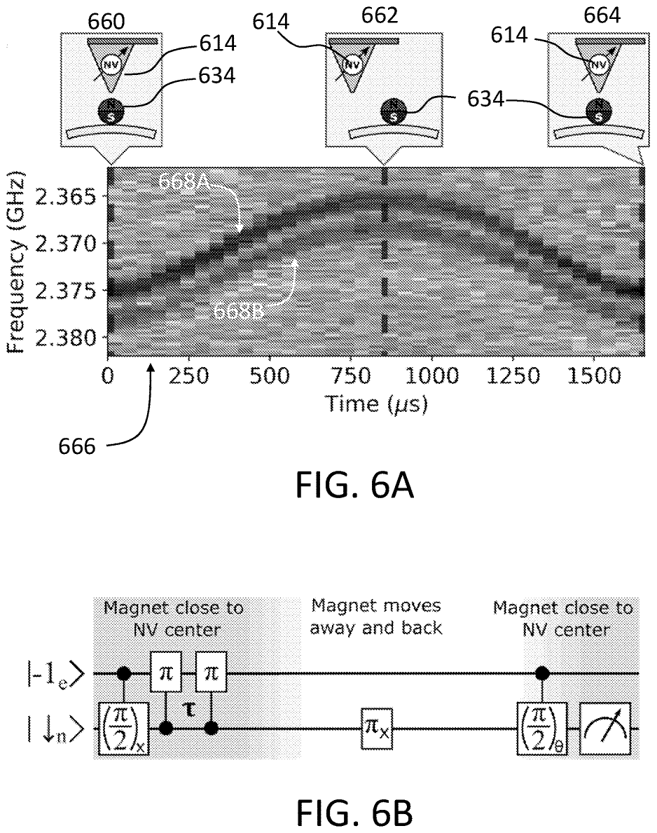

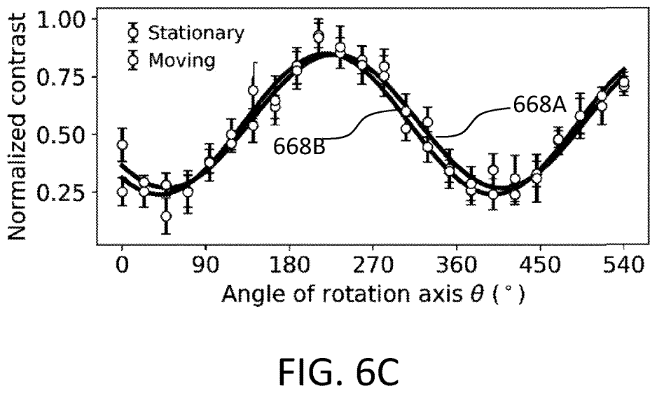

FIGS. 6A-6C show the preservation of spin coherence while moving in a magnetic field gradient. FIG. 6B shows an example pulse sequence that can be synchronized with relative movement between a qubit and micromagnet shown in FIG. 6A. In an example implementation, since the total movement time 1.7 ms is much longer than the electronic spin coherence time, the NV center's intrinsic 15N nuclear spin can be used as a quantum memory to enable the mechanical qubit transport over time periods longer than NV center's spin coherence time. FIG. 6C shows example measurements of the spin coherence both for example implementations where the micromagnet was moved and where the micromagnet was not moved.

FIG. 6A shows the relative distance introduced between qubit 614 and micromagnet 634 during timesteps 660, 662, and 664, according to some embodiments. As shown in FIG. 6A, a first relative difference is shown in timestep 660. In some embodiments, at timestep 662, the micromagnet 634 can be moved ~2 μm away from the diamond nanopillar housing spin qubit 614. After a period of time elapses (e.g., 1.7 ms), at timestep 664 the micromagnet 634 can be returned to its original position.

FIG. 6A also shows a graph 666 of pulsed electron paramagnetic response (ESR) measurements at different times during the movement sequence show the changing field from the moving micromagnet 634. In an example implementation with NV centers in diamond used to generate the data in FIG. 6A, a 3 MHz hyperfine splitting (lines 668A, 668B) from the NV center's intrinsic ¹⁵N nuclear spin can be seen. In some embodiments, an additional hyperfine splitting from a nearby ¹³C nuclear spin can also be observed using a different microwave pulse duration.

FIG. 6B shows an example pulse sequence used to demonstrate storage and retrieval of coherent information, synchronized with the movement sequence shown in FIG. 6A. For example, in timestep 660, when the micromagnet 634 is close to the qubit 614, the electron and ¹⁵N nuclear spin are first initialized in a two-qubit register |−1 [symbol] ⊗|↓ [symbol] , followed by a π/2-pulse which puts the ¹⁵N nuclear spin in a superposition |−1 [symbol] ⊗(|↓ [symbol] +|↑))ₙ. Subsequently, a CₙNOTₑ gate is applied which can fully entangle the electron-nucleus pair −|0 [symbol] |↓ [symbol] +|−1 [symbol] |↑ [symbol] . During the subsequent free evolution time τ, the entangled electron-nucleus pair accumulates a phase φ(τ). For an example NV center in an example implementation, hyperfine interactions with a nearby ¹³C nuclear spin lead to phase accumulation at a rate of ~0.9 MHz. A second CₙNOTₑ gate can be applied to disentangle the electron-nuclear pair, resulting in phase information φ(τ) being stored in the ¹⁵N nuclear spin |−1 [symbol] ₑ ⊗(−|↓ [symbol] +e^{iØ(τ)}|↑ [symbol] )ₙ.

Next, in timestep 662 when the micromagnet 634 is moved ~2 μm away from the diamond nanopillar housing spin qubit 614, the field at the nanopillar can change significantly during the movement sequence, leading to an additional phase accumulation on the ¹⁵N, in some embodiments. In some example implementations, this additional phase can be eliminated by applying a π-pulse on the ¹⁵N at approximately the middle of the movement sequence, as shown in FIG. 6B.

Finally, in timestep 664 when the micromagnet 634 is moved back in proximity to the qubit 614, a π/2-pulse at the end of the movement sequence converts the stored phase information φ(τ) into the probability of finding the ¹⁵N in either |↓ [symbol] or |↑ [symbol] , which can be measured using repetitive readout.

As shown in plot 666 of FIG. 6A, in an example implementation, pulsed ESR measurements at different times during the movement sequence 660, 662, 664, reveals a large change in the magnetic field environment, as evidenced by a shift of ~10 MHz in the ESR frequency. In an example implementation, fixing the phase accumulation time τ=900 ns, coherence of the nuclear spin at the end of the movement sequence 664 can be measured by varying the rotation axis angle θ of the final π/2-pulse, for both cases where the micromagnet is moved (line 668A) and kept stationary (line 668B). By fixing

$$τ = 900 ns < {T}_{2 , e}^{*}$$

and varying the rotation axis angle of the final π/2-pulse, the spin coherence preservation can be calculated. The results, shown in FIG. 6C, demonstrate that the normalized contrasts for cases where the micromagnet is moved (668B) and kept stationary (668A) are 0.61 (3) and 0.57 (3) respectively, indicating that the nuclear spin coherence is unaffected by the large change in magnetic field demonstrated by the ~10 MHz change in ESR frequency.

Embodiments and example implementations of the present disclosure demonstrate an architecture for programmable mechanically-mediated interactions between distant spin qubits. In some embodiments where qubits are implemented as NV centers and the NV centers' intrinsic nuclear spin memory is not degraded by movement inside a field gradient, for example if a decoupling pulse sequence is applied. Example movement distances of up to 2 μm exceeds the range of magnetic dipole-dipole interactions between spins presently available, and in some embodiments is limited only by the moving speed (which in some embodiments can be up to 1 mm/s) and nuclear spin coherence time (which in some embodiments can be roughly T_{2,n}~5 ms). These limits are only examples, and can be increased in some embodiments. For example, the speed can be increased by using a nanopositioner with a higher bandwidth and reducing/minimizing residual vibrations caused by scanning motion. In some embodiments, decoupling the spin qubit from its local environment or cooling to cryogenic temperatures can also extend T_{2,n} to up to 1 s, which can extend the possible distance to >1 mm even with more limited speeds.

Embodiments of the present disclosure also permit increasing the coupling strength between a qubit and a mechanical resonator in addition to minimizing noise. In some embodiments, without being bound by theory, the onset of coherent quantum phenomena can generally marked by the spin-mechanical cooperativity

$$C ≡ \frac{{λ}^{2}}{{Γ}_{{kn}_{th}}} {∼}^{>} 1 ,$$

which compares the coherent coupling rate λ to the dissipation rates Γ,ₖₙ_{ₜₕ} of the spin and mechanical mode respectively. While the cooperativity of some example implementations described herein exceeds previous spin-mechanical platforms involving NV centers, coupling can still be improved. For example, drift of the NV-magnet distance can cause large variations of the ESR frequency at high magnetic field gradients (e.g., at approximately 1.4×10⁶ T/m or more), limiting some example implementations of a field gradient to 2.4×10⁴ T/m at a distance of 1.0 μm. Improvements to the setup stability and the use of atomic-force microscopy (AFM) feedback, positioning the NV center at a reduced distance of 50 nm from the surface of a 1 μm-diameter micromagnet can yield gradients of up to ~1.4×10⁶ T/m, or a spin-mechanical coupling of up to λ/2π~800 Hz. In some embodiments, the disclosed doubly clamped microbeam can be replaced with designs that utilize strain engineering and soft-clamping, which have demonstrated Q of up to ~10⁹ at MHz frequencies. Even higher quality factors can been implemented by replacing silicon nitride with crystalline materials such as silicon and diamond. In some embodiments, for a coupling strength of up to λ/2π=800 Hz, an NV center electronic spin coherence time T_{2,e} of 10 ms, and a quality factor of 10⁹ at 4 K, the coherent coupling regime is possible with C ~75. In some embodiments, under such conditions, mechanics-mediated entanglement of electronic spins with fidelity exceeding 95% can be achieved (for example up to 99%, 99.9%, or 99.99%). In some embodiments, T_{2,e} can also improve with larger NV implantation depth (e.g., at a depth of approximately 10 nm or more from the surface and/or tip of the nanopillar). Improvements in diamond fabrication and surface termination can increase T_{2,e} to the 10 ms regime for NV centers in diamond nanopillars.

Spin-mechanical architectures featuring dynamical qubit transport, as described herein, can have the advantage of being able to generate programmable, non-local interactions, similar to reconfigurable platforms based on neutral atoms and trapped ions. In some embodiments, the long coherence time of the nuclear spin allows multiple distant spins to be dynamically transported to interact with the same mechanical resonator. Unlike most other hybrid quantum systems, the mechanical resonators and spin components of the present disclosure can have high coherence even at room temperature. For example, a nanomagnet diameter of 0.3 μm, an NV-magnet separation of 20 nm, spin coherence time of T_{2,e}=2 ms and Q=1×10⁹, coherent-coupling can be achieved at room temperature. Furthermore, the disclosed diamond nanopillars provide enhanced optical illumination and collection efficiency for the qubit.

Although embodiments and example implementations of the present disclosure describe qubits implemented as NV centers in diamond nanopillars, the various mechanically mediated coupling techniques described above are applicable to other qubit architectures, including but not limited to other solid state qubits, such as silicon vacancy centers in diamond, color centers in silicon carbide, and others, such as those that have been incorporated into nanopillars and/or nanopillar-like structures.

Although embodiments of the present disclosure describe the applicability of disclosed mechanically mediated coupling techniques to quantum registers, a person of ordinary skill in the art would understand from the present disclosure that the disclosed mechanically mediated coupling techniques have broader applicability to other fields, including but not limited to entanglement-enhanced quantum sensing.

While embodiments of the present disclosure describe using magnets at antinodes of motion of mechanical resonators for increased coupling, a person of skill in the art would recognize from the present disclosure would understand that magnets could be used at locations adjacent to or other than antinodes of motion of the mechanical resonators, and that such locations would simply produce less variation in the magnetic field because the amplitude of motion during vibration of the mechanical resonator would be less as compared to magnets at the antinodes of motion.

A person of ordinary skill in the art would understand from the present disclosure that each of the embodiments described above can be implemented with either nanomagnets or micromagnets. Likewise, a person of ordinary skill in the art would understand from the present disclosure that each of the embodiments described above can be implemented with either nanobeam, microbeam, or other resonator, such as membrane or a cantilever.

While the invention has been particularly shown and described with reference to specific preferred embodiments, it should be understood by those skilled in the art that various changes in form and detail can be made therein without departing from the spirit and scope of the invention as defined by the appended claims. Those skilled in the art would understand that particular measurements achieved during tests of the invention and numbers obtained during simulations of the invention do not limit the scope of the invention in any way, unless otherwise noted. Likewise, the theoretical explanations provided in the present disclosure to describe various aspects of the invention are merely examples and do not limit the scope of the invention, unless otherwise noted. A person of ordinary skill in the art would understand from the present disclosure that the disclosed embodiments can be selectively combined without departing from the scope of the disclosed invention.

1. An apparatus, comprising:
a plurality of scanning probes, each scanning probe having a spin qubit;
a mechanical resonator; and
at least one magnet attached to the mechanical resonator, the at least one magnet configured to couple a mechanical resonance of the mechanical resonator to:
a spin state of a spin qubit of a first scanning probe of the plurality of scanning probes, and
a spin qubit of a second scanning probe of the plurality of scanning probes such that the spin state of the spin qubit of the first scanning probe is entangled with the spin qubit of the second scanning probe.

2. The apparatus of claim 1, wherein one or more of the at least one magnet, the first scanning probe, or the second scanning probe is configured to move such that:
the at least one magnet is configured to couple the mechanical resonance of the mechanical resonator to the spin state of the spin qubit of the first scanning probe of the plurality of scanning probes when the at least one magnet is in proximity to the spin qubit of the first scanning probe, and
the at least one magnet is configured to couple the mechanical resonance of the mechanical resonator to the spin qubit of the second scanning probe of the plurality of scanning probes such that the spin state of the spin qubit of the first scanning probe is entangled with the spin qubit of the second scanning probe when the at least one magnet is in proximity to the spin qubit of the second scanning probe.

3. The apparatus of claim 1, wherein the at least one magnet comprises at least two magnets attached to the mechanical resonator;
one of the at least two magnets is configured to couple the mechanical resonance of the mechanical resonator to the spin state of the spin qubit of the first scanning probe; and
another of the at least two magnets is configured to couple the mechanical resonance of the mechanical resonator to the spin qubit of the second scanning probe such that the spin state of the spin qubit of the first scanning probe is entangled with the spin qubit of the second scanning probe.

4. The apparatus of claim 3, wherein the one of the at least two magnets is in proximity to the spin qubit of the first scanning probe and the another of the at least two magnets is in proximity to the spin qubit of the second scanning probe such that the spin state of the spin qubit of the first scanning probe is entangled with the spin qubit of the second scanning probe.

5. The apparatus of claim 3, wherein one or more of the at least two magnets, the first scanning probe, or the second scanning probe are configured to move such that:
the one of the at least two magnets is in proximity to the spin qubit of the first scanning probe, and
the another of the at least two magnets is in proximity to the spin qubit of the second scanning probe.

6. The apparatus of claim 1, wherein the at least one magnet comprises one magnet.

7. The apparatus of claim 1, wherein the mechanical resonator comprises a nanobeam, a microbeam, a membrane, or a cantilever.

8. The apparatus of claim 1, wherein the mechanical resonator comprises silicon nitride, silicon, or diamond.

9. The apparatus of claim 1, wherein the at least one magnet comprises at least one micromagnet.

10. The apparatus of claim 1, wherein the plurality of scanning probes comprise nanopillars.

11. The apparatus of claim 1, wherein the plurality of scanning probes comprise a tapered cylinder shape.

12. The apparatus of claim 1, wherein the plurality of scanning probes comprise diamond or silicon carbide.

13. The apparatus of claim 1, wherein the spin state of spin qubit on the first scanning probe is configured to be set by microwave control of the electronic spin or by a laser.

14. The apparatus of claim 13, wherein the microwave control is configured to be supplied to the spin qubit of the first scanning probe by a coplanar waveguide, an antenna, or a wire loop.

15. The apparatus of claim 1, wherein one or more of the spin state of the spin qubit of the first scanning probe and the spin state of the spin qubit of the second scanning probe is configured to be read by a laser.

16. The apparatus of claim 1, wherein one or more of the spin state of the spin qubit of the first scanning probe and the spin state of the spin qubit of the second scanning probe are configured to be transferred into long-lived nuclear spin states when the at least one magnet is in proximity to the spin qubit of the first scanning probe or the spin qubit of the second scanning probe, respectively.

17. The apparatus of claim 1, further comprising:
a second mechanical resonator; and
a second at least one magnet attached to the second mechanical resonator, the second at least one magnet configured to couple a mechanical resonance of the second mechanical resonator to:
a spin state of a spin qubit of a third scanning probe of the plurality of scanning probes, and
a spin qubit of a fourth scanning probe of the plurality of scanning probes such that the spin state of the spin qubit of the third scanning probe is entangled with the spin qubit of the second scanning probe.

18. The apparatus of claim 1, wherein the plurality of scanning probes comprise at least one array of scanning probes and the mechanical resonance of the mechanical resonator is selectively couplable to respective spins of spin qubits of scanning probes on the at least one array of scanning probes.

19. A method, comprising:
setting a spin state of a spin qubit on a first scanning probe;
coupling a mechanical resonance of a mechanical resonator to the spin state of the spin qubit on the first scanning probe using at least one magnet attached to the mechanical resonator; and
coupling the mechanical resonance of the mechanical resonator to a spin qubit of a second scanning probe using the at least one magnet such that the spin state of the spin qubit on the first scanning probe is entangled with the spin qubit of the second scanning probe.

20. The method of claim 19, wherein coupling the mechanical resonance of the mechanical resonator to the spin qubit of the second scanning probe comprises:
moving one or more of the second scanning probe or the at least one magnet such that the at least one magnet is in proximity to the spin qubit of the second scanning probe.

21. The method of claim 19, wherein the at least one magnet comprises at least two magnets attached to the mechanical resonator, and coupling the mechanical resonance of the mechanical resonator to the spin qubit of the second scanning probe comprises:
coupling the mechanical resonance of the mechanical resonator to the spin state of the spin qubit of the first scanning probe using one of the at least two magnets; and
coupling the mechanical resonance of the mechanical resonator to the spin qubit of the second scanning probe such that the spin state of the spin qubit of the first scanning probe is entangled with the spin qubit of the second scanning probe using a second one of the at least two magnets.

22. The method of claim 19, further comprising moving the one of the at least two magnets into proximity to the spin qubit of the first scanning probe and moving the another of the at least two magnets is in proximity to the spin qubit of the second scanning probe such that the spin state of the spin qubit of the first scanning probe is entangled with the spin qubit of the second scanning probe.

23. The method of claim 19, further comprising one or more of the at least two magnets, the first scanning probe, or the second scanning probe such that:
the one of the at least two magnets is in proximity to the spin qubit of the first scanning probe, and
the another of the at least two magnets is in proximity to the spin qubit of the second scanning probe.

24. The method of claim 19, wherein the mechanical resonator comprises a nanobeam, a microbeam, a membrane, or a cantilever.

25. The method of claim 19, wherein the mechanical resonator comprises silicon nitride, silicon, or diamond.

26. The method of claim 19, wherein the at least one magnet comprises at least one micromagnet.

27. The method of claim 19, wherein the plurality of scanning probes comprise nanopillars.

28. The method of claim 19, wherein the plurality of scanning probes comprise a tapered cylinder shape.

29. The method of claim 19, wherein the plurality of scanning probes comprise diamond or silicon carbide.

30. The method of claim 19, further comprising setting the spin state of spin qubit on the first scanning probe by microwave control of the electronic spin or by a laser.

31. The method of claim 30, further comprising supplying the microwave control to the spin qubit of the first scanning probe by a coplanar waveguide, an antenna, or a wire loop.

32. The method of claim 19, further comprising reading the one or more of the spin state of the spin qubit of the first scanning probe and the spin state of the spin qubit of the second scanning probe by a laser.

33. The method of claim 19, further comprising transferring one or more of the spin state of the spin qubit of the first scanning probe and the spin state of the spin qubit of the second scanning probe into long-lived nuclear spin states when the at least one magnet is in proximity to the spin qubit of the first scanning probe or the spin qubit of the second scanning probe, respectively.

34. The method of claim 19, further comprising:
coupling a mechanical resonance of a second mechanical resonator to the spin state of the spin qubit on a third scanning probe using a second at least one magnet attached to the second mechanical resonator; and
coupling the mechanical resonance of the second mechanical resonator to a spin qubit of a fourth scanning probe using the second at least one magnet such that the spin state of the spin qubit on the third scanning probe is entangled with the spin qubit of the fourth scanning probe.

35. The method of claim 19, wherein the plurality of scanning probes comprise at least one array of scanning probes and the mechanical resonance of the mechanical resonator is selectively couplable to respective spins of spin qubits of scanning probes on the at least one array of scanning probes.

36. The method of claim 19, wherein the at least one magnet comprises one magnet.
